(19) United States
(12) Patent Application Publication
(10) Pub. No.: US 2025/0232496 A1
(43) Pub. Date: Jul. 17, 2025

(54) MACHINE LEARNING TO GENERATE MULTIMEDIA VISUALIZATIONS

(71) Applicant: THE BOEING COMPANY, Arlington, VA (US)

(72) Inventors: Lakshmi ETHIRAJAN, Bangalore (IN); Manoj NATH, Bangalore (IN)

(21) Appl. No.: 18/412,315

(22) Filed: Jan. 12, 2024

(51) Int. Cl. G06T 11/60; G06F 3/04817; G06F 40/284; G06F 40/289

(52) U.S. Cl. CPC G06T 11/60; G06F 40/284; G06F 40/289; G06F 3/04817

(57) ABSTRACT

The present disclosure provides techniques for visualization generation using machine learning. A set of textual data is divided into a plurality of text chunks. A plurality of text summaries is generated based on processing the plurality of text chunks using one or more machine learning models. A plurality of keywords is generated based on processing at least one of the plurality of text chunks or the plurality of text summaries using the one or more machine learning models. A visualization template, from a library of visualization templates, is selected based on at least one of the plurality of keywords. A set of icons, from a library of icons, is selected based on at least one of the plurality of keywords. A visualization is generated using the visualization template and the set of icons and using at least one of the plurality of text summaries.

### FIELD

Aspects of the present disclosure relate to machine learning. More specifically, aspects of the present disclosure relate to machine learning-based data visualization.

### BACKGROUND

Visuals can help users quickly interpret complex information. Infographics are multimedia visual representations of information, often including charts, icons, or other graphical illustrations with minimal text. Manually summarizing information into an infographic representation is not only a time-consuming activity, but also requires additional skills in terms of tools and domain knowledge. As data and information has become increasingly abundant and accessible, even preliminary searches on virtually any topic yields a vast array of resources in various formats, such as articles, audio podcasts, videos, and the like. Browsing through such large volumes of data takes substantial time and effort. Further, it is difficult for users to grasp the overall message even after going through the contents, which is especially important for things like training, official presentations, technical articles, blogs, and the like.

Though pictorial summaries of the information (e.g., infographics) can provide a quick overview of the data, creating them manually is a time-consuming activity, and requires substantial domain knowledge and software skills. Additionally, when multiple representations are created to cater to different audiences, the required manual effort increases proportionately.

### SUMMARY

The present disclosure provides a method in one aspect, the method including: dividing a set of textual data into a plurality of text chunks; generating a plurality of text summaries based on processing the plurality of text chunks using one or more machine learning models; generating a plurality of keywords based on processing at least one of the plurality of text chunks or the plurality of text summaries using the one or more machine learning models; selecting a first visualization template, from a library of visualization templates, based on at least one of the plurality of keywords; selecting a first set of icons, from a library of icons, based on at least one of the plurality of keywords; and generating a first visualization using the first visualization template and the first set of icons and using at least one of the plurality of text summaries.

In one aspect, in combination with any example method above or below, the method further includes: accessing audio data comprising natural language audio; delineating the audio data into a set of audio segments; generating a set of text transcriptions by processing each respective audio segment, of the set of audio segments, using a speech-to-text machine learning model; and concatenating the set of text transcriptions to form the set of textual data.

In one aspect, in combination with any example method above or below, the method further includes receiving a set of user keywords from a user, wherein generating at least one of the plurality of text chunks or the plurality of text summaries is performed based at least in part on the set of user keywords.

In one aspect, in combination with any example method above or below, dividing the set of textual data into the plurality of text chunks comprises identifying split points in the set of textual data based on (i) a defined minimum number of summaries, (ii) a defined maximum number of words per text chunk, and (iii) locations of end-of-sentence tokens in the set of textual data.

In one aspect, in combination with any example method above or below, selecting the first visualization template comprises: identifying a set of template keywords associated with the first visualization template; computing a similarity score between the set of template keywords and the at least one of the plurality of keywords; and selecting the first visualization template based on the similarity score.

In one aspect, in combination with any example method above or below, selecting the first set of icons comprises: identifying a set of icon keywords associated with a first icon of the set of icons; computing a similarity score between the set of icon keywords and the at least one of the plurality of keywords; and selecting the first icon for inclusion in the first set of icons based on the similarity score.

In one aspect, in combination with any example method above or below, the method further includes at least one of: (i) receiving a title from a user, or (ii) generating a title based on processing at least one of the plurality of text chunks or the plurality of text summaries using the one or more machine learning models, wherein generating the first visualization comprises adding the title to the first visualization.

In one aspect, in combination with any example method above or below, the method further includes: dividing the set of textual data into a new plurality of text chunks; generating a new plurality of text summaries based on processing the new plurality of text chunks using the one or more machine learning models; generating a new plurality of keywords based on processing at least one of the new plurality of text chunks or the new plurality of text summaries using the one or more machine learning models; selecting a second visualization template, from the library of visualization templates, based on at least one of the new plurality of keywords; selecting a second set of icons, from the library of icons, based on at least one of the new plurality of keywords; and generating a second visualization using the second visualization template and the second set of icons and using at least one of the new plurality of text summaries.

In one aspect, in combination with any example method above or below, the method further includes outputting the first visualization via one or more display devices.

Other aspects of this disclosure provide one or more non-transitory computer-readable media containing, in any combination, computer program code that, when executed by the operation of a computer system, performs operations in accordance with one or more of the above methods, as well as systems comprising one or more computer processors and one or more memories containing computer-executable instructions that, when executed by the one or more computer processors, perform operations in accordance with one or more of the above methods.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 depicts an example workflow for generating visualizations using machine learning, according to some aspects of the present disclosure.

FIG. 2 depicts example visualization template and icon libraries for generating visualizations using machine learning, according to some aspects of the present disclosure.

FIG. 3 is a flow diagram depicting an example method for using machine learning to generate visualizations, according to some aspects of the present disclosure.

FIG. 4 is a flow diagram depicting an example method for visualization generation, according to some aspects of the present disclosure.

FIG. 5 depicts an example computing device for visualization generation, according to some aspects of the present disclosure.

### DETAILED DESCRIPTION

The present disclosure provides a machine learning-based visualization generator. As used herein, a “visualization” generally corresponds to multimedia (but primarily visual) content (e.g., an infographic) having various icons, text portions, and the like. In some aspects, the visualization generator can be used to provide a crisp and intuitive pictorial summary, for any kind of input, which assists users in grasping the contents quickly. In some aspects, the system is able to dynamically regenerate the visualizations (e.g., generating an entirely new visualization having different content based on the same input data), ensuring that users can generate multiple infographics and create different visualizations of the same information.

In some aspects, the visualization system can provide dynamic summarization of any inputs (e.g., audio, video, voice, text input, and the like) using a variety of natural language processing (NLP) techniques. In some aspects, the visualization system may use generative artificial intelligence (AI) techniques. In some aspects, the input contents are provided to a preprocessor component, which uses various tools such as video converters and speech-to-text machine learning model(s) and/or algorithm(s), to consolidate the input into a text document. In some aspects, from this text, a summary (or summaries) can be generated using pre-trained language models (e.g., large language models (LLMs)). In some aspects, along with the summary (or summaries), keywords associated with each of the summary entries can be extracted or generated.

In some aspects, using these keywords, relevant icons and graphic assets can be selected from an image or icon library. Further, in some aspects, a suitable visualization template can be identified based on context such as the topic, the keywords, and the like. An intuitive visualization can then be generated automatically. Advantageously, such AI-based graphic generation not only provides a quick overview of the contents, but also reduces the cognitive load or the mental energy required to interpret the contents. Aspects of the present disclosure can thereby thus provide a crisp summary in near real-time.

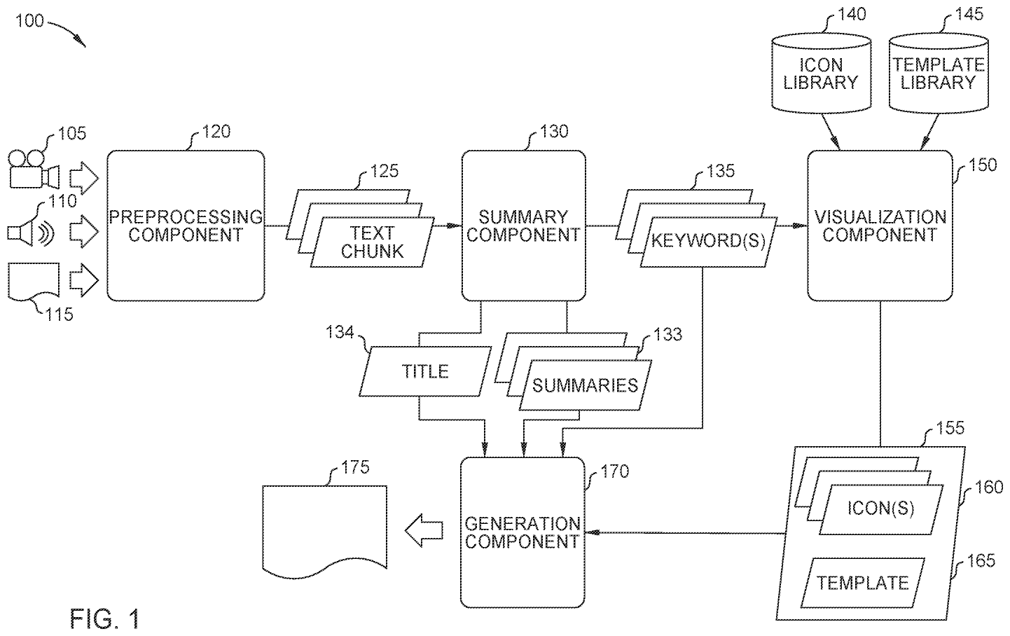

FIG. 1 depicts an example workflow 100 for generating visualizations using machine learning, according to some aspects of the present disclosure. In some aspects, the workflow 100 is performed by a visualization system (e.g., a computing system configured to generate visualizations using machine learning). That is, the depicted components (e.g., the preprocessing component 120, the summary component 130, the visualization component 150, and the generation component 170) may be components of a visualization system. Generally, the operations of the depicted components may be combined or distributed across any number of components and systems, and may be implemented using hardware, software, or a combination of hardware and software.

In the illustrated workflow 100, a variety of input data are accessed by a preprocessing component 120. As used herein, “accessing” data may generally include receiving, retrieving, requesting, collecting, generating, obtaining, or otherwise gaining access to the data. In the illustrated example, the input data may include video data 105 (depicted as a camera for conceptual clarity), audio data 110 (depicted as a speaker for conceptual clarity), and/or text data 115. Generally, each of the inputs may include natural language information. For example, the video data 105 may include one or more videos conveying content or information, such as speeches, presentations, voiceover explanations, and the like. In some aspects, the video data 105 may include audio (e.g., recorded spoken natural language) and/or text (e.g., graphics or other text displayed in the video). As another example, the audio data 110 may generally include recording(s) of spoken natural language (e.g., an audio recording of a presentation). The text data 115 may similarly include natural language text.

The preprocessing component 120 may generally access or receive the inputs from a variety of sources. In some aspects, a user may provide the input. For example, a user may provide a link (e.g., a hyperlink to a web address) where the video data 105, audio data 110, and/or text data 115 is located. As another example, the user may directly upload video data 105, audio data 110, and/or text data 115 to the preprocessing component 120. In some aspects, the user may record the video data 105 and/or audio data 110 directly, and/or may copy and paste or otherwise type the text data 115 into a field provided by the visualization system.

In the illustrated workflow 100, the preprocessing component 120 performs a variety of operations based on the input data to generate a set of text chunks 125. Generally, each text chunk 125 contains natural language text (e.g., one or more sentences) gleaned from the input data. Delineating the text into independent text chunks 125 may facilitate summarization and keyword generation, reducing computational expense (as compared to evaluating the entire set of text as a single document) and improving accuracy of the resulting output. In some aspects, the particular operations used by the preprocessing component 120 may vary depending on the particular content or format of the input data.

For example, for video data 105, the preprocessing component 120 may extract any included audio and apply one or more speech-to-text transcription techniques (e.g., machine learning models trained to generate text based on spoken natural language) to generate a textual transcription of the audio. In some aspects, to reduce computational expense and improve results, the preprocessing component 120 may first divide or delineate the audio into a set of audio segments, and process each separately using the transcription model. The resulting set of text transcriptions may then be concatenated in order (based on the order of the audio segments) to create a set of textual data (e.g., a single document containing a transcription of the natural language spoken in the video data 105). In some aspects, the preprocessing component 120 may further use one or more techniques such as optical character recognition (OCR) to identify any written text in the video data 105 (e.g., graphics, overlays, slides, and the like). In some aspects, this written text may further be included in the set of textual data (e.g., concatenated at the beginning or end, or inserted into the text such that the written text is inserted at or near to the corresponding transcription text). Though not included in the illustrated example, in some aspects, the preprocessing component 120 may similarly evaluate image data using OCR to extract textual data.

As another example, for audio data 110, the preprocessing component 120 may similarly apply one or more speech-to-text transcription techniques (e.g., machine learning models trained to generate text based on spoken natural language) to generate a textual transcription of the audio. In some aspects, to reduce computational expense and improve results, the preprocessing component 120 may first divide or delineate the audio into a set of audio segments, and process each separately using the transcription model. The resulting set of text transcriptions may then be concatenated in order (based on the order of the audio segments) to create a set of textual data (e.g., a single document containing a transcription of the natural language spoken in the audio data 110).

As another example, for text data 115, the preprocessing component 120 may perform preprocessing operations such as removing formatting and blank spaces to generate textual data based on the input.

In some aspects, the preprocessing component 120 may evaluate one or more sets of input data to generate a single visualization. For example, a user may provide a single video, multiple videos, a video and audio, audio and text, and the like. Generally, the preprocessing component 120 may perform various operations to generate a set of textual data (e.g., a single document containing all of the natural language text from any input source). For example, the preprocessing component 120 may concatenate the textual data from multiple videos or other sources to yield a single set of textual data for the input.

In some aspects, the preprocessing component 120 may perform one or more additional preprocessing operations on this textual data, such as cleaning or correcting errors, running spell-check, adding punctuation, and the like. In the illustrated example, the preprocessing component 120 then delineates or divides the (single) set of textual data into the text chunks 125.

The preprocessing component 120 may generally perform a variety of operations to generate the text chunks 125. For example, in some aspects, the preprocessing component 120 may divide the textual data into text chunks 125 of equal length (e.g., each having N words or characters). In some aspects, the preprocessing component 120 may divide the textual data based on various (potentially user-configurable) hyperparameters, such as a defined minimum number of summaries (e.g., indicating that the visualization system should attempt to find at least N summaries or key points for the input data, and the preprocessing component 120 should therefore generate at least N text chunks 125). In some aspects, the preprocessing component 120 may divide the textual data based at least in part on a defined maximum size (e.g., a defined maximum number of words or characters) for each text chunk 125 (e.g., indicating that no chunk should exceed M words or characters). In some aspects, this maximum length may be defined based on the downstream machine learning models (e.g., based on the maximum length of data they can use as input), user preference, and the like. In some aspects, the preprocessing component 120 divides the textual data based at least in part on the locations of end-of-sentence tokens in the textual data (e.g., periods, exclamation points, question marks, and the like). For example, the preprocessing component 120 may generate text chunks 125 such that at least N chunks are created, no chunk is longer than the defined maximum length, and/or that the delineations are made at end-of-sentence tokens (e.g., such that a single sentence is not split across two text chunks 125).

In some aspects, in addition to or instead of such a hyperparameter-based approach, the preprocessing component 120 may perform text chunking using one or more machine learning models (e.g., language models). For example, the preprocessing component 120 may process the textual data using one or more language models to create logical semantic text chunks 125 (e.g., based on the content or context of each), such that each text chunk 125 corresponds to a logically-related and/or semantically-related set of sentences.

In the illustrated example, the text chunks 125 are accessed by a summary component 130, which evaluates the text chunks 125 using one or more machine learning models to generate a set of summaries 133 (referred to in some aspects as text summaries) and a set of keywords 135. In some aspects, the summary component 130 generates a respective summary 133 for each respective text chunk 125. Further, in some aspects, the summary component 130 generates a set of one or more keywords 135 based on each respective summary 133. In some aspects, rather than evaluating each text chunk 125 to generate a corresponding set of keywords 135, the summary component 130 may additionally or alternatively evaluate the corresponding summary 133 when generating the keywords 135.

In some aspects, the summary component 130 uses one or more machine learning models (e.g., generative AI models such as LLMs) to generate the summaries 133 and keywords 135. Generally, a wide variety of models and techniques may be used, depending on the particular implementation. In some aspects, the text summarization performed by the summary component 130 can be broadly classified into two types: extractive summarization and abstractive summarization. In the extractive text summarization approach, the summary component 130 may identify important sentences and/or phrases from the text chunk 125 to form the corresponding summary 133. For example, the summary component 130 may rank each sentence in a text chunk 125 based on the sentence's importance (e.g., as determined based on how representative the sentence is with respect to the chunk, the length of the sentence with respect to other sentences in the chunk, and the like), and use one or more of the highest-ranked sentences as the summary 133. In the abstractive approach, the summary component 130 may generates new sentences and/or phrases based on the text chunk 125, while maintaining the essence of the original content. This new text may be used as the corresponding summary 133.

In some aspects, to generate the summaries 133, the summary component 130 may process each text chunk 125 using one or more trained machine learning models, such as encoder-decoder architectures, autoregressive models, text-to-text translation or transcription models, and the like. In some aspects, the summary component 130 may use multiple different models to process each text chunk 125, resulting in multiple different summaries 133 for each chunk. For example, the summary component 130 may compare the summaries 133 for a given text chunk 125 and use various qualitative techniques to select which summary 133 to use for the chunk (e.g., based on how representative each summary 133 is with respect to the chunk). In some aspects, the user may specify which model(s) or technique(s) to use to generate the summaries 133. In some aspects, the visualization system may generate multiple different visualizations by using multiple different summarization models. This may cause the visualizations to differ somewhat (e.g., because the summaries 133 may be somewhat different), while still generally conveying the same information.

In the illustrated workflow 100, the summary component 130 also generates a set of keywords 135 based on the text chunks 125. That is, for each text chunk 125, the summary component 130 may extract or generate a set of one or more keywords 135. In some aspects, one or more pre-trained language machine learning models may also be used for this keyword extraction in an extractive and/or abstractive manner. For example, in some aspects, the summary component 130 may generate word embeddings for each word in the text chunk 125, and use cosine similarity between each embedding to find the key words or phrases that are similar to the text chunk 125 itself (e.g., the word(s) and/or phrase(s) having an embedding that is most similar to the embedding of the text chunk 125).

In some aspects, in a similar manner to the summaries 133, the summary component 130 may use multiple different models or techniques to process each text chunk 125, resulting in multiple different sets of keywords 135 for each text chunk 125. For example, the summary component 130 may compare the sets of keywords 135 for a given text chunk 125 and use various qualitative techniques to select which set of keywords 135 to use. In some aspects, the user may specify which model(s) or technique(s) to use to generate the keywords 135. In some aspects, the visualization system may generate multiple different visualizations by using multiple different keyword models. This may cause the visualizations to differ somewhat (e.g., because the keywords 135 may be somewhat different), while still generally conveying the same information.

In the illustrated example, the summary component 130 can also generate a title 134 based on processing the text chunks 125 and/or the summaries 133. For example, in some aspects, the visualization system may use one or more machine learning models (e.g., a pre-trained LM that has been fine-tuned on title data) to predict or generate a title 134 based on input textual content (e.g., the text chunks 125 and/or the summaries 133). The visualization system may use such a model to process the text chunks 125 (generated by the preprocessing component 120), to process one or more of the summaries 133, and/or to process one or more of the keywords 135 in order to generate a title 134.

In the illustrated workflow 100, the keywords 135, summaries 133, and title 134 are provided to a generation component 170, discussed in more detail below. Further, as illustrated, the keywords 135 are provided to a visualization component 150.

As illustrated, the visualization component 150 accesses the keywords 135 and uses them to search an icon library 140 and a template library 145 to generate a selection 155 having a selected template 165 and a selected set of icons 160. Generally, the icon library 140 corresponds to one or more data stores or sources having icons (e.g., graphical elements) that can be incorporated into visualizations. In some aspects, each icon in the icon library 140 has an associated set of one or more keywords describing the icon's appearance, content, context, and the like. For example, for an icon depicting a key, the keywords may include terms such as “key,” “safe,” “secure,” “lock,” “unlock,” and the like.

The icon library 140 may generally correspond to one or more data sources which may be stored locally by the visualization system and/or accessed from one or more remote repositories. In some aspects, some or all of the icon keywords may be manually generated. In some aspects, some or all of the icon keywords may be generated using one or more machine learning models. For example, each icon may be processed using one or more computer vision (CV) models (e.g., object recognition models) to generate textual keywords for each icon.

In the illustrated example, the template library 145 corresponds to one or more data stores or sources having visualization templates (e.g., indicating fields where text can be inserted, locations where icons can be added, and the like) that can be used to generate visualizations (e.g., by populating the template with icons and/or text). In some aspects, each template in the template library 145 has an associated set of one or more keywords describing the template's appearance, content, context, and the like. For example, for a template that has potential icon locations arranged in a tree structure, the keywords may include terms such as “tree,” “hierarchy,” “branching,” and the like.

The template library 145 may generally correspond to one or more data sources which may be stored locally by the visualization system and/or accessed from one or more remote repositories. In some aspects, some or all of the template keywords may be manually generated. In some aspects, some or all of the template keywords may be generated using one or more machine learning models. For example, each template may be processed using one or more computer vision (CV) models (e.g., object recognition models) to generate textual keywords for each template.

In some aspects, the visualization component 150 selects the template 165 and icons 160 based on the sets of keywords 135 for each summary 133. For example, for each summary 133, the visualization component 150 may generate one or more similarity scores (e.g., based on cosine distance) between each keyword 135 in the set of corresponding keywords and each keyword associated with one or more templates in the template library 145. The visualization component 150 may then select the template(s) having the highest similarity score (e.g., where the keywords 135 are most similar to the template's keywords). In some aspects, based on the selected template 165, the visualization component 150 can then determine how many elements or components will be used (e.g., how many icons, how much text, and the like).

The visualization component 150 may similarly generate one or more similarity scores (e.g., based on cosine distance) between each keyword 135 in the sets of keywords and each keyword associated with one or more icons in the icon library 140. In some aspects, for each set of keywords 135 (e.g., for each summary 133), the visualization component 150 may then select a corresponding icon, having the highest similarity to the set of keywords, for inclusion.

In some aspects, rather than evaluating all sets of keywords 135 to select the icon(s), the visualization component 150 may evaluate a subset of the sets. For example, suppose the summary component 130 generated ten summaries 133 (and ten corresponding sets of keywords 135), but the selected template has spots for seven icons/sections. In some aspects, the visualization system may identify the seven most-important summaries 133 (e.g., the summaries 133 that are most representative of the overall textual data), and select an icon for each such summary 133 based on the corresponding sets of keywords 135.

In the illustrated example, the selections 155 are then provided to the generation component 170. As illustrated, the generation component 170 further accesses the summaries 133, keywords 135, and title 134. In the depicted workflow 100, the generation component 170 generates a visualization 175 using the selected template 165 and icons 160, along with the title 134, summaries 133, and/or keywords 135. For example, in some aspects, the generation component 170 fills the template 165 with the icons 160, and adds text (e.g., some or all of the keywords 135 and/or summaries 133) to each corresponding icon as appropriate, as well as adding the title 134.

For example, suppose one summary 133 includes “The new system is able to dramatically reduce cybersecurity risks,” the corresponding set of keywords 135 include “cybersecurity,” and the selected icon 160 for the summary 133 is a picture of a computer. In some aspects, the generation component 170 may add the selected icon 160 to a designated field in the selected template 165, add the keyword “cybersecurity” as a label for the icon, and/or add the summary “The new system is able to dramatically reduce cybersecurity risks” as the content for the icon.

In this way, the generation component 170 is able to combine summaries 133 and/or keywords 135 with selected icons 160 according to a selected template 165 in order to dynamically and automatically generate a visualization 175 that accurately and appropriately summarizes the input data in a multimedia format.

In some aspects, as discussed above, the visualization 175 may be provided or returned to the requesting user (e.g., the user that provided or pointed to the input data). In some aspects, the visualization 175 is output via one or more displays (e.g., a computer monitor) for the user to review. In some aspects, the user may make tweaks or suggestions, such as to rearrange the icons, modify any included text, and the like. In some aspects, the user may request that the generation component 170 re-generate the visualization 175.

In some aspects, as discussed above, the visualization system may use one or more other machine learning models to generate new summaries 133 and keywords 135 in order to generate the new visualization. For example, if a first LLM was used to generate the first visualization 175, the visualization system may use a different LLM or another model architecture to generate the second visualization. Generally, this process may be repeated any number of times until the user is satisfied with the visualization 175.

Although not depicted in the illustrated example, in some aspects, the user can optionally provide one or more keywords to seed or guide the summarization process. For example, in addition to providing a video of a presentation, the user may also provide keywords (referred to in some aspects as user keywords) indicating the content they are interested in (e.g., indicating that the visualization system should generate an infographic, based on the video, focusing on content related to “cybersecurity”). In some aspects, the summary component 130 may use these seed keywords to condition the summarization (e.g., to condition the generative AI), ensuring that the summaries 133 and keywords 135 are more likely to be related to the provided keyword(s).

Although not depicted in the illustrated example, in some aspects, the user may specify or provide the title to be added. This title may be used as part of the generation process (e.g., used as a seed or guide for the summarization) in some aspects.

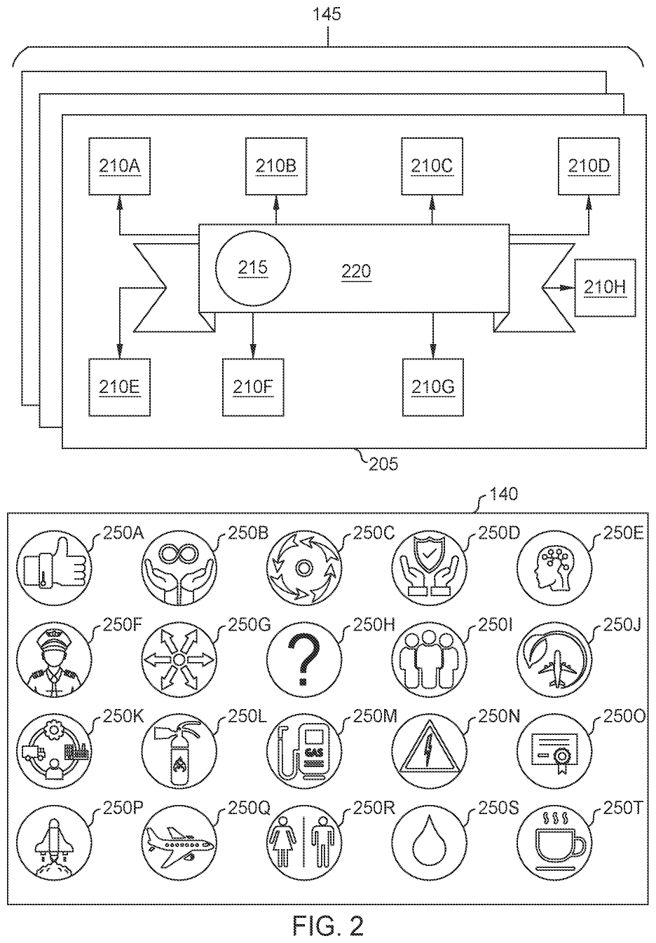

FIG. 2 depicts example visualization template library 145 and an icon library 140 for generating visualizations using machine learning, according to some aspects of the present disclosure.

In the illustrated example, the template library 145 includes at least one template 205. In an aspect, each template 205 is generally a visual structure having a set of fields arranged spatially around the template 205. In some aspects, each template 205 may further include various graphical elements, such as lines or arrows connecting fields and other elements, colors, imagery, and the like. In the illustrated example, the template 205 includes a banner (labeled 220 in FIG. 2) in the middle of the template 205, with a set of square fields 210A-H arranged around the edges of the template 205 (and connected to the banner via corresponding lines or links), along with a circular field 215 within the banner 220.

As discussed above, in some aspects, the visualization system may add in one or more icons and/or text content to each field 210 and 215 in the template 205. For example, in the illustrated template 205, the visualization system may add the title to the banner 220, and add an icon to the field 215 (e.g., the selected icon that corresponds to the most-important summary or keyword). Further, each other field 210 may be populated with a corresponding icon and/or text data (e.g., the corresponding keyword(s) for each other icon, the corresponding summary, and the like).

For example, continuing the cybersecurity example above, the banner 220 may be labeled “New Cybersecurity System” and the field 215 may be populated with an icon of a computer. The other fields 210 may include icons such as a key and a lock, a smiling user, and the like. In some aspects, the other fields 210 may further be updated with text such as “new encryption techniques substantially reduce risk.”

In some aspects, as discussed above, the template 205 is associated with a set of template keywords that can be used to select which template 205, from the template library 145, should be used. That is, based on the keyword(s) generated based on user input, the visualization system may identify which template(s) 205 are most similar to the generated keyword(s), and select these template(s).

In some aspects, as discussed above, some or all of the template keywords may be manually curated (e.g., a user or administrator may provide keywords describing the templates 205). In some aspects, some or all of the template keywords may be automatically generated. For example, the visualization system (or another system) may process the template 205 using one or more machine learning models trained to generate textual descriptions of image input. These textual descriptions may then be used as the keywords, and/or the visualization system may process the textual descriptions to generate keywords (e.g., as discussed above with reference to summary and keyword generation).

In the illustrated example, the icon library 140 contains a set of icons 250A-T. Each icon 250 is generally a graphical element that can be used to populate visualizations. For example, the icons 250 may include clip art, images or photographs, and the like. In the illustrated example, the icon 250A is a thumbs-up gesture, the icon 250B is two hands beneath an infinity sign, and so on.

In some aspects, as discussed above, each icon 250 is associated with a set of icon keywords that can be used to select which icon(s) 250, from the icon library 140, should be used. That is, based on the keyword(s) generated based on user input, the visualization system may identify which icon(s) 250 are most similar to the generated keyword(s), and select these icon(s).

For example, if one set of keywords includes terms such as “pilot,” the visualization system may select the icon 250F, which depicts a pilot. Similarly, if one set of keywords includes terms such as “fuel,” the visualization system may select the icon 250M, which depicts a fuel pump.

In some aspects, as discussed above, some or all of the icon keywords may be manually curated (e.g., a user or administrator may provide keywords describing the icons 250). In some aspects, some or all of the icon keywords may be automatically generated. For example, the visualization system (or another system) may process each icon 250 using one or more machine learning models trained to generate textual descriptions of image input. These textual descriptions may then be used as the keywords, and/or the visualization system may process the textual descriptions to generate keywords (e.g., as discussed above with reference to summary and keyword generation).

Generally, as discussed above, the visualization system may evaluate any number templates 205 and icons 250 from any number and variety of template libraries 145 and icon libraries 140 to select, for a given request, a specific template 205 and a specific set of icons 250. The selected template 205 and icons 250 may then be combined, along with text in some aspects, to generate a compelling visualization.

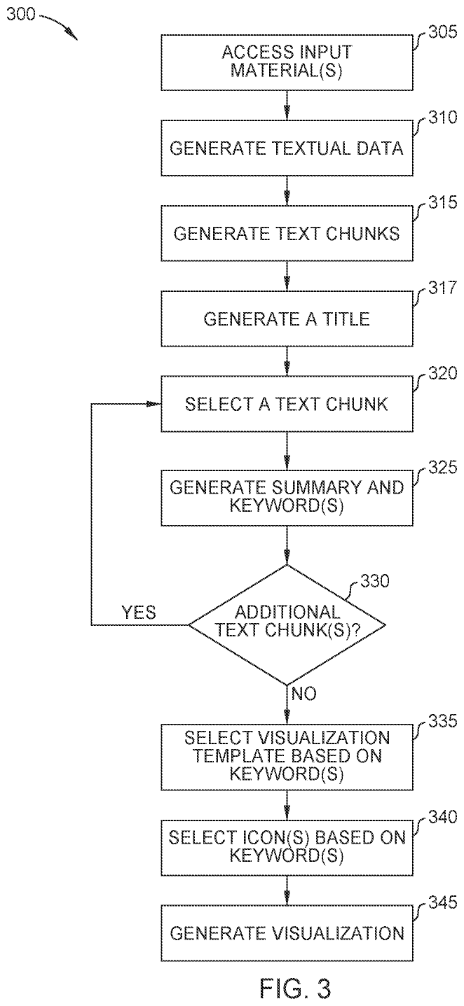

FIG. 3 is a flow diagram depicting an example method 300 for using machine learning to generate visualizations, according to some aspects of the present disclosure. In some aspects, the method 300 is performed by a visualization system, such as the visualization system discussed above with reference to FIGS. 1 and 2.

At block 305, the visualization system accesses input materials. For example, as discussed above, the visualization system may access video (such as video data 105 of FIG. 1), audio (such as audio data 110 of FIG. 1), text (such as text data 115 of FIG. 1), and/or images. In some aspects, as discussed above, the input materials may be provided or selected by a user. For example, the user may upload the materials, or may provide a link to the materials.

At block 310, the visualization system generates textual data based on the input materials. For example, as discussed above, for video data, the visualization system may extract the audio and apply one or more speech-to-text models to generate a text transcription of any natural language contained therein. In some aspects, as discussed above, the visualization system may delineate or divide the audio into shorter segments, and process each segment separately. The resulting transcriptions may then be concatenated to form the textual data. Audio data may be similarly processed.

In some aspects, as discussed above, the visualization system may further perform various cleaning or other preprocessing operations, such as to remove blank spaces, add punctuation, correct typographical and/or grammatical errors, and the like. In some aspects, if multiple sets of input materials are provided (e.g., multiple videos, a video and audio, a video and text, and the like), the visualization system may concatenate the resulting text from each to form a single document of textual data.

At block 315, the visualization system generates text chunks (e.g., text chunks 125 of FIG. 1) based on the textual data. As discussed above, each text chunk generally comprises a subset of words from the textual data. For example, the visualization system may divide the textual data into N chunks. In some aspects, as discussed above, the visualization system may generate the chunks based on hyperparameters such as a preferred maximum length of each chunk, a preferred minimum number of summaries or key points, and the like. In some aspects, the visualization system may delineate the chunks based at least in part on end-of-sentence token, to ensure that sentences are not split across multiple chunks.

In some aspects, as discussed above, the visualization system may use one or more machine learning models to generate the chunks (e.g., to parse the textual data and identify break points where the text transitions to a different logical or semantic concept).

At block 317, the visualization system optionally generates a title based on processing the text chunks. In some aspects, as discussed above, the visualization system may process one or more of the text chunks using one or more machine learning models in order to generate a title. In some aspects, in addition to or instead of evaluating the text chunks, the visualization system may evaluate the text summaries, keywords, or other textual data to generate the title. Further, in some aspects, a user may provide the title.

At block 320, the visualization system selects one of the text chunks. Generally, the visualization system may use a variety of techniques to select the text chunk, including randomly or pseudo-randomly, as each text chunk will be processed during the method 300.

At block 325, the visualization system generates a text summary (e.g., a summary 133 of FIG. 1) and a set of one or more keyword(s) (e.g., keywords 135 of FIG. 1) for the selected chunk. For example, as discussed above, the visualization system may process the text chunk using one or more machine learning models (e.g., extractive models, generative models, and the like) to generate a summary of the chunk.

In some aspects, to generate the keyword(s) for the chunk, the visualization system may process the text chunk (or the summary generated for the chunk) using one or more machine learning models to identify or generate the key words and/or phrases for the chunk, as discussed above.

In some aspects, the model(s) used to generate the summary and keyword(s) may be specified by a user. In some aspects, the model(s) used may be selected by the visualization system. For example, in some aspects, the visualization system may randomly select one or more model(s). In this way, the generated visualizations may differ somewhat.

In some aspects, as discussed above, the visualization system may generate the summary and/or keyword(s) based at least in part on one or more keywords or prompts provided by the user to guide the summarization process.

At block 330, the visualization system determines whether there is at least one additional text chunk remaining to be processed. If so, the method 300 returns to block 320. If not, the method 300 continues to block 335. Although the illustrated example depicts a sequential process for conceptual clarity (e.g., selecting and evaluating each text chunk iteratively), in some aspects, the visualization system may process some or all of the text chunks in parallel.

At block 335, the visualization system selects a visualization template (e.g., the selected template 165 of FIG. 1 and/or the template 205 of FIG. 2), from a template library (e.g., the template library 145 of FIGS. 1-2), based on one or more set(s) of keyword(s) generated for one or more of the text chunks. For example, as discussed above, the visualization system may determine the cosine similarity or distance between a set of template keyword(s) associated with a given template and each keyword generated for the input materials. The template having the highest similarity (or lowest distance) may then be selected as the template for the input materials.

At block 340, the visualization system selects one or more icons (e.g., the selected icons 160 of FIG. 1 and/or the icons 250 of FIG. 2), from an icon library (e.g., the icon library 140 of FIGS. 1-2), based on one or more set(s) of keyword(s) generated for one or more of the text chunks. For example, as discussed above, the visualization system may determine the cosine similarity or distance between a set of icon keyword(s) associated with a given icon and each keyword generated for a given text chunk. For each text chunk, the visualization system may then select the icon having the highest similarity (or lowest distance). In some aspects, as discussed above, the visualization system may select icons for a subset of the text chunks (e.g., if the selected visualization template has fewer fields than there are text chunks).

At block 345, the visualization system then generates a visualization (e.g., the visualization 175 of FIG. 1) based on the selected template, icon(s), summaries, keyword(s), and/or title. For example, as discussed above, the visualization system may fill each designated field or space in the selected template with a selected icon, and add optionally add text (e.g., one or more corresponding keywords, or the corresponding text summary itself) to the field or space.

In some aspects, the visualization system may add a variety of other user-provided data, such as image(s), text, and the like.

In some aspects, the visualization system may then output or display the visualization to the user, allowing the user to make any tweaks or revisions. In some aspects, the user may select to regenerate the visualization. In some aspects, the visualization system may respond by returning to a prior operation (e.g., returning to block 320) to re-generate a new summary and set of keywords for each text chunk (e.g., using different machine learning model(s)). In some aspects, in addition to or instead of regenerating the summaries, the visualization system may select a new visualization template and/or a new set of icons. For example, the visualization system may determine to select the second-highest scored template, as the user may have not liked the highest-scored template.

In some aspects, this regeneration process may be repeated any number of times. In some aspects, the user may specify which portion(s) should be regenerated. For example, the user may indicate that the content is acceptable, but that a new template and/or new icons should be used. In response, the visualization system may refrain from regenerating the summaries, and may instead select a different template and/or set of icons. As another example, the user may indicate that the template and/or icons are acceptable, but the content is not. In response, the visualization system may generate new summaries and/or keywords, but re-use the same previous icon(s) and/or template. As yet another example, if the user indicates that a specific portion of the content is insufficient, the visualization system may generate a new summary for the indicated content (e.g., reprocessing the specific text chunk), while retaining the other summaries and icons unchanged.

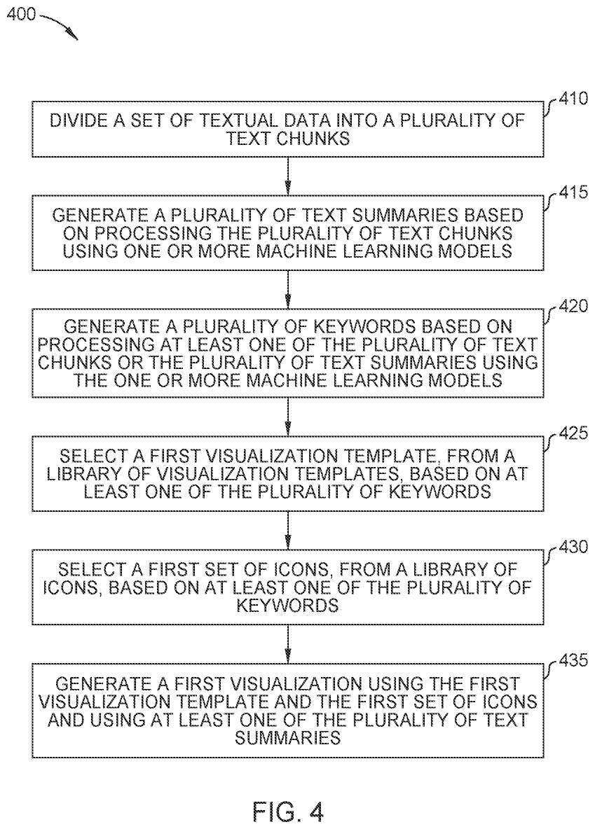

FIG. 4 is a flow diagram depicting an example method 400 for visualization generation, according to some aspects of the present disclosure. In some aspects, the method 400 is performed by a visualization system, such as the visualization system discussed above with reference to FIGS. 1-3.

At block 410, a set of textual data is divided into a plurality of text chunks (e.g., the text chunks 125 of FIG. 1).

At block 415, a plurality of text summaries (e.g., the summaries 133 of FIG. 1) is generated based on processing the plurality of text chunks using one or more machine learning models.

At block 420, a plurality of keywords (e.g., the keywords 135 of FIG. 1) is generated based on processing at least one of the plurality of text chunks or the plurality of text summaries using the one or more machine learning models.

At block 425, a first visualization template (e.g., the template 165 of FIG. 1) is selected, from a library of visualization templates (e.g., the template library 145 of FIG. 1), based on at least one of the plurality of keywords.

At block 430, a first set of icons (e.g., the icons 160 of FIG. 1) is selected, from a library of icons (e.g., the icon library 140 of FIG. 1), based on at least one of the plurality of keywords.

At block 435, a first visualization (e.g., the visualization 175 of FIG. 1) is generated using the first visualization template and the first set of icons and using at least one of the plurality of text summaries.

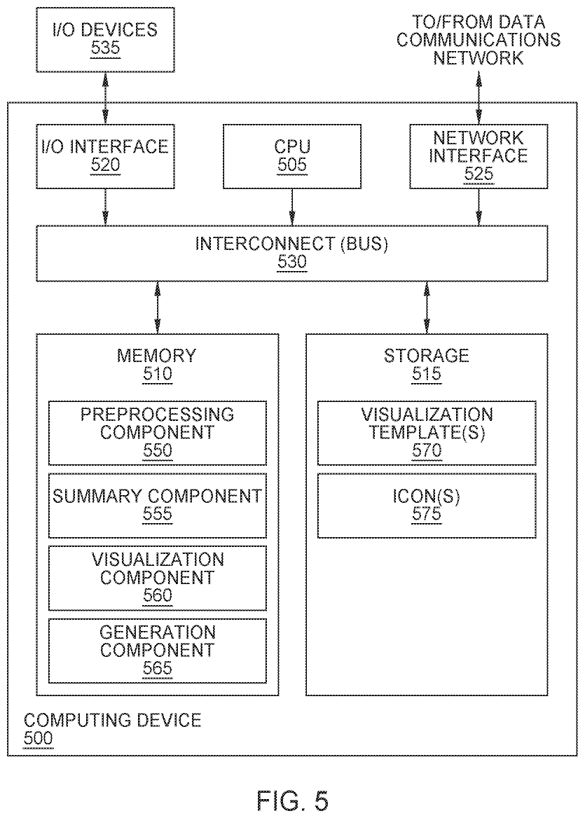

FIG. 5 depicts an example computing device 500 for visualization generation, according to some aspects of the present disclosure.

Although depicted as a physical device, in some aspects, the computing device 500 may be implemented using virtual device(s), and/or across a number of devices (e.g., in a cloud environment). In some aspects, the computing device 500 corresponds to or comprises a visualization system, such as the visualization system discussed above with reference to FIGS. 1-4.

As illustrated, the computing device 500 includes a CPU 505, memory 510, storage 515, one or more network interfaces 525, and one or more I/O interfaces 520. In the illustrated aspect, the CPU 505 retrieves and executes programming instructions stored in memory 510, as well as stores and retrieves application data residing in storage 515. The CPU 505 is generally representative of a single CPU and/or GPU, multiple CPUs and/or GPUs, a single CPU and/or GPU having multiple processing cores, and the like. The memory 510 is generally considered to be representative of a random access memory. Storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 535 (such as keyboards, monitors, etc.) are connected via the I/O interface(s) 520. Further, via the network interface 525, the computing device 500 can be communicatively coupled with one or more other devices and components (e.g., via a network, which may include the Internet, local network(s), and the like). As illustrated, the CPU 505, memory 510, storage 515, network interface(s) 525, and I/O interface(s) 520 are communicatively coupled by one or more buses 530. In the illustrated aspect, the memory 510 includes a preprocessing component 550, a summary component 555, a visualization component 560, and a generation component 565.

Although depicted as discrete components for conceptual clarity, in some aspects, the operations of the depicted components (and others not illustrated) may be combined or distributed across any number of components. Further, although depicted as software residing in memory 510, in some aspects, the operations of the depicted components (and others not illustrated) may be implemented using hardware, software, or a combination of hardware and software.

In the illustrated aspect, the preprocessing component 550 (which may correspond to the preprocessing component 120 of FIG. 1) is used to preprocess input materials (e.g., images, video, audio, and/or text) to generate textual data, as discussed above. In some aspects, the preprocessing component 550 may further process the textual data to generate text chunks (e.g., text chunks 125 of FIG. 1), as discussed above.

In the illustrated example, the summary component 555 (which may correspond to the summary component 130 of FIG. 1) generally uses one or more algorithms, machine learning models, and/or operations to generate textual summaries and keywords based on input text. For example as discussed above, the summary component 555 may process each text chunk using one or more machine learning models to generate a corresponding summary (e.g., the summary 133 of FIG. 1). Additionally, the summary component 555 may process each summary using one or more machine learning models (which may be the same models, or a different set of models) to generate keyword(s) (e.g., the keywords 135 of FIG. 1) for the text chunk.

In the illustrated aspect, the visualization component 560 (which may correspond to the visualization component 150 of FIG. 1) may be used to select visualization components based on the generated keywords. For example, as discussed above, the visualization component 560 may use the keyword(s) for one or more chunks to select a visualization template (e.g., the template 165 of FIG. 1), from a repository of templates (e.g., the template library 145 of FIG. 1), having similar keywords or labels. Similarly, the visualization component 560 may use the keyword(s) for each chunk to select an icon (e.g., the icon 160 of FIG. 1), from a repository of icons (e.g., the icon library 140 of FIG. 1), having similar keywords or labels.

In the illustrated example, the generation component 565 (which may correspond to the generation component 170 of FIG. 1) may be used to compile the generated and selected data to generate visualizations (e.g., the visualization 175 of FIG. 1). For example, the generation component 565 may fill in the designated fields or spaces in the selected template using the selected icon(s), add one or more keywords or summaries to each such field or space, add a title to the visualization, and the like.

In the illustrated example, the storage 515 may include a set of visualization templates 570 (which may correspond to the template library 145 of FIG. 1) and a set of icons 575 (which may correspond to the icon library 140 of FIG. 1). As discussed above, the visualization templates 570 generally include templates for infographics, such as specifying a spatial arrangement of locations where icons can be inserted and/or fields where text can be inserted. The icons 575 generally correspond to visual or graphic elements that can be inserted into infographics. In some aspects, as discussed above, each of the visualization templates 570 and icons 575 may be associated with corresponding keywords or labels indicating the context(s) when the template or icon may be relevant or useful. In some aspects, the aforementioned data may be saved in a remote database that connects to the computing device 500 via a network.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method, comprising:
dividing a set of textual data into a plurality of text chunks;
generating a plurality of text summaries based on processing the plurality of text chunks using one or more machine learning models;
generating a plurality of keywords based on processing at least one of the plurality of text chunks or the plurality of text summaries using the one or more machine learning models;
selecting a first visualization template, from a library of visualization templates, based on at least one of the plurality of keywords;
selecting a first set of icons, from a library of icons, based on at least one of the plurality of keywords; and
generating a first visualization using the first visualization template and the first set of icons and using at least one of the plurality of text summaries.

2. The method of claim 1, further comprising:
accessing audio data comprising natural language audio;
delineating the audio data into a set of audio segments;
generating a set of text transcriptions by processing each respective audio segment, of the set of audio segments, using a speech-to-text machine learning model; and
concatenating the set of text transcriptions to form the set of textual data.

3. The method of claim 1, further comprising receiving a set of user keywords from a user, wherein generating at least one of the plurality of text chunks or the plurality of text summaries is performed based at least in part on the set of user keywords.

4. The method of claim 1, wherein dividing the set of textual data into the plurality of text chunks comprises identifying split points in the set of textual data based on (i) a defined minimum number of summaries, (ii) a defined maximum number of words per text chunk, and (iii) locations of end-of-sentence tokens in the set of textual data.

5. The method of claim 1, wherein selecting the first visualization template comprises:
identifying a set of template keywords associated with the first visualization template;
computing a similarity score between the set of template keywords and the at least one of the plurality of keywords; and
selecting the first visualization template based on the similarity score.

6. The method of claim 1, wherein selecting the first set of icons comprises:
identifying a set of icon keywords associated with a first icon of the set of icons;
computing a similarity score between the set of icon keywords and the at least one of the plurality of keywords; and
selecting the first icon for inclusion in the first set of icons based on the similarity score.

7. The method of claim 1, further comprising at least one of: (i) receiving a title from a user, or (ii) generating a title based on processing at least one of the plurality of text chunks or the plurality of text summaries using the one or more machine learning models, wherein generating the first visualization comprises adding the title to the first visualization.

8. The method of claim 1, further comprising:
dividing the set of textual data into a new plurality of text chunks;
generating a new plurality of text summaries based on processing the new plurality of text chunks using the one or more machine learning models;
generating a new plurality of keywords based on processing at least one of the new plurality of text chunks or the new plurality of text summaries using the one or more machine learning models;
selecting a second visualization template, from the library of visualization templates, based on at least one of the new plurality of keywords;
selecting a second set of icons, from the library of icons, based on at least one of the new plurality of keywords; and
generating a second visualization using the second visualization template and the second set of icons and using at least one of the new plurality of text summaries.

9. The method of claim 1, further comprising outputting the first visualization via one or more display devices.

10. A system comprising:
one or more memories collectively storing computer-executable instructions; and
one or more processors configured to collectively execute the computer-executable instructions and cause the system to perform an operation comprising:
dividing a set of textual data into a plurality of text chunks;
generating a plurality of text summaries based on processing the plurality of text chunks using one or more machine learning models;
generating a plurality of keywords based on processing at least one of the plurality of text chunks or the plurality of text summaries using the one or more machine learning models;
selecting a first visualization template, from a library of visualization templates, based on at least one of the plurality of keywords;
selecting a first set of icons, from a library of icons, based on at least one of the plurality of keywords; and
generating a first visualization using the first visualization template and the first set of icons and using at least one of the plurality of text summaries.

11. The system of claim 10, the operation further comprising:
accessing audio data comprising natural language audio;
delineating the audio data into a set of audio segments;
generating a set of text transcriptions by processing each respective audio segment, of the set of audio segments, using a speech-to-text machine learning model; and
concatenating the set of text transcriptions to form the set of textual data.

12. The system of claim 10, the operation further comprising receiving a set of user keywords from a user, wherein generating at least one of the plurality of text chunks or the plurality of text summaries is performed based at least in part on the set of user keywords.

13. The system of claim 10, wherein selecting the first visualization template comprises:
identifying a set of template keywords associated with the first visualization template;
computing a similarity score between the set of template keywords and the at least one of the plurality of keywords; and
selecting the first visualization template based on the similarity score.

14. The system of claim 10, wherein selecting the first set of icons comprises:
identifying a set of icon keywords associated with a first icon of the set of icons;
computing a similarity score between the set of icon keywords and the at least one of the plurality of keywords; and
selecting the first icon for inclusion in the first set of icons based on the similarity score.

15. The system of claim 10, further comprising:
dividing the set of textual data into a new plurality of text chunks;
generating a new plurality of text summaries based on processing the new plurality of text chunks using the one or more machine learning models;
generating a new plurality of keywords based on processing at least one of the new plurality of text chunks or the new plurality of text summaries using the one or more machine learning models;
selecting a second visualization template, from the library of visualization templates, based on at least one of the new plurality of keywords;
selecting a second set of icons, from the library of icons, based on at least one of the new plurality of keywords; and
generating a second visualization using the second visualization template and the second set of icons and using at least one of the new plurality of text summaries.

16. One or more non-transitory computer-readable media containing, in any combination, computer program code that, when executed by operation of a computer system, performs an operation comprising:
dividing a set of textual data into a plurality of text chunks;
generating a plurality of text summaries based on processing the plurality of text chunks using one or more machine learning models;
generating a plurality of keywords based on processing at least one of the plurality of text chunks or the plurality of text summaries using the one or more machine learning models;
selecting a first visualization template, from a library of visualization templates, based on at least one of the plurality of keywords;
selecting a first set of icons, from a library of icons, based on at least one of the plurality of keywords; and
generating a first visualization using the first visualization template and the first set of icons and using at least one of the plurality of text summaries.

17. The one or more non-transitory computer-readable media of claim 16, the operation further comprising:
accessing audio data comprising natural language audio;
delineating the audio data into a set of audio segments;
generating a set of text transcriptions by processing each respective audio segment, of the set of audio segments, using a speech-to-text machine learning model; and
concatenating the set of text transcriptions to form the set of textual data.

18. The one or more non-transitory computer-readable media of claim 16, the operation further comprising receiving a set of user keywords from a user, wherein generating at least one of the plurality of text chunks or the plurality of text summaries is performed based at least in part on the set of user keywords.

19. The one or more non-transitory computer-readable media of claim 16, wherein selecting the first visualization template comprises:
identifying a set of template keywords associated with the first visualization template;
computing a similarity score between the set of template keywords and the at least one of the plurality of keywords; and
selecting the first visualization template based on the similarity score.

20. The one or more non-transitory computer-readable media of claim 16, wherein selecting the first set of icons comprises:
identifying a set of icon keywords associated with a first icon of the set of icons;
computing a similarity score between the set of icon keywords and the at least one of the plurality of keywords; and
selecting the first icon for inclusion in the first set of icons based on the similarity score.
